(19) United States
(12) Patent Application Publication
(10) Pub. No.: US 2010/0011491 A1
(43) Pub. Date: Jan. 21, 2010

(54) Garment Having a Vascular System for Facilitating Evaporative Cooling of an Individual

(76) Inventors: Richard Goldmann, Poughkeepsie, NY (US); Russ Weinzimmer, Milford, NH (US); Douglas P. Burum, Acton, MA (US)

Correspondence Address: Russ Weinzimmer, 614 Nashua Street, Suite 53, Milford, NH, 03055, US

(21) Appl. No.: 12/176,878

(22) Filed: Jul. 21, 2008

(51) Int. Cl. A62B 17/00; A41B 1/00; A41D 1/00; A41D 13/00

(52) U.S. Cl. 2/458; 2/115; 2/69

(57) ABSTRACT

A cooling garment is disclosed that enhances the comfort of an exercising, working, or resting individual by reducing overheating, perspiration, dehydration, and electrolyte loss. A vascular distribution system delivers water to the garment, and evaporation cools the individual. Wetness can be concentrated where needed and moderated by water absorbent materials such as gel polymers. Water flows under gravity, by capillary action, pumping, or air pressurization. The garment can include inner layers that improve comfort, absorb perspiration, keep the individual at least partly dry, and/or include metallic and/or polymeric and/or other materials that conduct heat. Cooling can be enhanced by garment texture that increases evaporative surface area. Water can be chilled before it is delivered to the fabric, and ports can be included to allow a water bottle or other water source to be temporarily connected, and/or allow the individual to drink the water and/or pressurize a water container.

### FIELD OF THE INVENTION

The invention generally relates to apparatus for cooling individuals, and more specifically to apparatus for cooling individuals with water.

### BACKGROUND OF THE INVENTION

Exercise is generally known to have many benefits for individuals of all ages. These benefits include improved cardiovascular health, reduced blood pressure, prevention of bone and muscle loss, maintenance of a healthy weight, improved psychological heath, and many others. However, exercise is generally accompanied by a certain degree of discomfort, including overheating, sweating, etc, and this leads to a significant reduction in the intensity, duration, and frequency of exercise undertaken by many individuals, thereby reducing the health benefits that can be derived from recreational and conditioning exercise. Excess heating during exercise can also reduce peak athletic performance, because the performance of a muscle deteriorates when the muscle is overheated.

Overheating of an individual can also occur during leisure activities due to exposure to sunlight and other warm weather conditions. Such overheating can reduce the comfort of these activities and shorten the amount of time that they can be enjoyed. In addition, individuals can become overheated while performing work in a hot environment, either indoors or outdoors, thereby decreasing their productivity and comfort, and possibly even endangering their health.

The body's primary method of cooling when overheated is perspiration. Perspiration is highly effective because water has a high heat capacity and a high heat of vaporization, and so the evaporation of perspiration is an efficient mechanism for eliminating unwanted heat. However, there are several major disadvantages to perspiration, including dehydration, loss of electrolytes, and unwanted odors.

There are many approaches known for helping to keep an exercising or working individual cool, thereby reducing perspiration and discomfort. For example, if the exercise takes place indoors, the ambient air in the exercise environment can be maintained at a low temperature by an air conditioning system. However, cooling by this method is limited because air has a low heat capacity and does not make good thermal contact with the body. Fans and humidifiers can be used to increase heat transfer from the body of an exerciser to the air, but these approaches still cannot provide sufficient cooling in all cases. When exercise occurs outdoors, these approaches are largely unavailable.

For similar reasons, there are few satisfactory approaches known for cooling an individual during an outdoor work or leisure activity when sunlight and/or warm weather lead to overheating of the individual. Cool air can be directed onto the individual, but the low heat capacity of cool air limits its effectiveness.

### SUMMARY OF THE INVENTION

A garment is claimed with a vascular water distribution system that can deliver water to the garment so as to efficiently cool the individual by evaporation of the water while the individual is exercising or taking part in other activities that could lead to overheating. The apparatus provides efficient cooling of the individual, thereby reducing perspiration and associated dehydration, loss of electrolytes, odors, and discomfort.

The garment includes fabric formed so as to cover at least a portion of the body of the individual, and a vascular water distribution system cooperative with the fabric, connectable to a source of water, and able to distribute water over an area of the fabric, thereby enabling evaporative cooling of a portion of the body of the individual. In preferred embodiments the vascular water distribution system is attached to the fabric by one or more of: hook-and-loop fabric attachment; glue; tie strips; magnetic attachment; buttons; hooks; pins; and snaps. And in some embodiments, at least part of the vascular water distribution system is embedded or woven into the fabric.

In preferred embodiments water flows through the vascular water distribution due to pressurizing the water, due to gravity, and/or due to capillary action. And in certain preferred embodiments the vascular water distribution system is in thermal contact with the individual, thereby allowing water flowing through the vascular water distribution system to cool the individual.

In various embodiments the vascular water distribution system includes a connecting port that is temporarily connectable to a source of water. And in some embodiments the garment includes a drinking port that that is attachable to the source of water and can be used by the individual to drink from the source of water and/or to push water into the vascular water distribution system by blowing into the drinking port.

In certain preferred embodiments the fabric forms a shirt, shorts, or a hat, and in some embodiments the fabric brings water into physical contact with the individual.

The garment can include a thermally conducting inner layer with a side that is in thermal contact with the individual and a side that is in thermal contact with the water. The thermally conducting inner layer can contain metal and/or thermally conducting polymer, and can inhibit water from coming into contact with the individual.

In certain embodiments the fabric includes an inner layer that improves the comfort of the individual, absorbs perspiration, and/or resists exposure of the skin of the individual to water. And in some embodiments at least one quality of the fabric is non-uniform, such that the fabric tends to concentrate water in areas where evaporative cooling is most desirable. In other embodiments the fabric includes a water absorbent substance embedded in the fabric that moderates the wetness of the fabric by absorbing water from the fabric when too much is applied by the vascular water distribution system, and releasing water into the fabric when insufficient water is applied by the vascular water distribution system.

In preferred embodiments the fabric includes outer surface shaping that provides increased surface area, so as to increase evaporative cooling. In some of these embodiments the fabric is either uniform in thickness, such that the fabric includes both outer surface shaping and inner surface shaping, or non-uniform in thickness, such that the fabric includes only outer surface shaping.

In some preferred embodiments the fabric includes a thermally conducting inner layer and a water absorbent outer layer, the water absorbent outer layer being uniform in thickness and including both outer and inner shaping, the inner layer having a side that is in thermal contact with the individual and a side that is in thermal contact with the outer layer, the side that is in thermal contact with the outer layer conforming in shape to the inner surface shaping of the outer layer.

In preferred embodiments, the garment includes a source of water that is able to supply water to the vascular water distribution system. The source of water can include a water chiller that is able to cool the water before it is distributed by the vascular water distribution system. In some embodiments the source of water includes a pump operable by the individual so as to pump water into the vascular water distribution system, and in some of these embodiments the pump is operated automatically when the body of the individual undergoes movements such as breathing, walking, moving of arms, and moving of legs.

In certain embodiments where the garment includes a source of water that is able to supply water to the vascular water distribution system, the source of water includes an air space cooperative with water contained in the source of water, the air space being fillable with compressed air so as to apply pressure to the water, thereby pushing the water into the vascular water distribution system. And in some of these embodiments the air space is separated from the water in the source of water by a flexible barrier that is able to apply pressure to the water while ensuring that only water will be delivered by the source of water to the vascular water distribution system. In other of these embodiments the source of water includes a pump operable by the individual so as to compress the air in the air space, and in some of these embodiments the pump is operated automatically when the body of the individual undergoes movements such as breathing, walking, moving of arms, and moving of legs.

In further embodiments where the garment includes a source of water that is able to supply water to the vascular water distribution system, the source of water includes a water container that can be compressed by the individual so as to push water into the vascular water distribution system. And in other of these embodiments at least some of the water supplied by the source of water is maintained in thermal contact with the individual before it is delivered to the vascular water distribution system.

### BRIEF DESCRIPTION OF THE DRAWINGS

FIG. 1 is a perspective drawing of a shirt with a vascular water distribution system through which water flows under pressure;

FIG. 2A is a close-up drawing of the fabric used in the shirt of FIG. 1, showing water being distributed into the fabric of the shirt;

FIG. 2B is a close-up cross sectional view of the fabric used in the shirt of FIG. 1, showing water being distributed into the fabric of the shirt;

FIG. 3 is perspective drawing of a shirt with a vascular water distribution system that draws water through themselves by capillary action;

FIG. 4A through FIG. 4H inclusively are cross sectional views of different fabric embodiments with the vascular water distribution system embedded in the fabric, where:

FIG. 4A is similar to FIG. 2B, FIG. 4B is similar to FIG. 4A but with an inner lining added;

FIG. 4C is similar to FIG. 4A but with outer surface shaping and a smooth inner surface;

FIG. 4D is similar to FIG. 4C, but with outer and inner surface shaping, so as to provide a uniform thickness;

FIG. 4E combines the features of FIG. 4B and FIG. 4C;

FIG. 4F combines the features of FIG. 4B and FIG. 4D, with the inner lining filling the voids in the inner surface of the fabric;

FIG. 4G is similar to FIG. 4F but with an innermost lining added that absorbs perspiration and increases user comfort; and

FIG. 4H is similar to FIG. 4A but with particles embedded in the fabric that moderate the wetness of the fabric by absorbing excess water and releasing water when too little is present;

FIG. 5 is a perspective drawing of an exerciser using a stationary exercise device with a cooling shirt, cooling headband, wetness sensor, and fan;

FIG. 6A is a perspective drawing of an exerciser on a bicycle wearing the shirt illustrated in FIG. 1, the vascular water distribution system being supplied with water by gravity from a bottle carried on the rider's back;

FIG. 6B is a perspective drawing of the embodiment of FIG. 6A, with the water bottle strapped to the support bar of the bicycle and pumped to the vascular water distribution system;

FIG. 6C is a perspective drawing of an exerciser on a bicycle wearing shorts with a vascular water distribution system, the shorts being supplied with water by gravity from a bottle carried on the rider's back;

FIG. 6D is a cross-sectional side drawing of a water bottle that uses air compressed in a space above the water to push water into the vascular water distribution system;

FIG. 6E is a cross-sectional side drawing of a water bottle that uses air compressed in a bladder surrounding the water to push water into the vascular water distribution system;

FIG. 6F is a cross sectional drawing of the water bottle of FIG. 6E oriented at right angles to the drawing of FIG. 6E;

FIG. 7A is a perspective view of a runner wearing the shirt of FIG. 3 and carrying a water bottle;

FIG. 7B is a perspective of the runner illustrated in FIG. 7A, with the water bottle connected to the water cooling system of the shirt;

FIG. 8 is a perspective view of an exerciser on a stationary exercise device wearing a shirt with a vascular water distribution system attached to it, to which chilled water is supplied by a water chiller;

FIG. 9A is a perspective view of a worker painting the exterior of a house while wearing a shirt with a vascular water distribution system, a source of water, and a hand pump for pumping water into the vascular water distribution system;

FIG. 9B is a perspective view of a worker painting the exterior of a house while wearing a shirt with a vascular water distribution system, a source of water, and a hand pump for pumping compressed air into the source of water so as to force water into the vascular water distribution system; and

FIG. 9C is a perspective view of a worker painting the exterior of a house while wearing a shirt with a vascular water distribution system, a source of water, and a pump activated automatically by movement of the painter's leg for pumping compressed air into the source of water so as to force water into the vascular water distribution system.

### DETAILED DESCRIPTION OF PREFERRED EMBODIMENTS

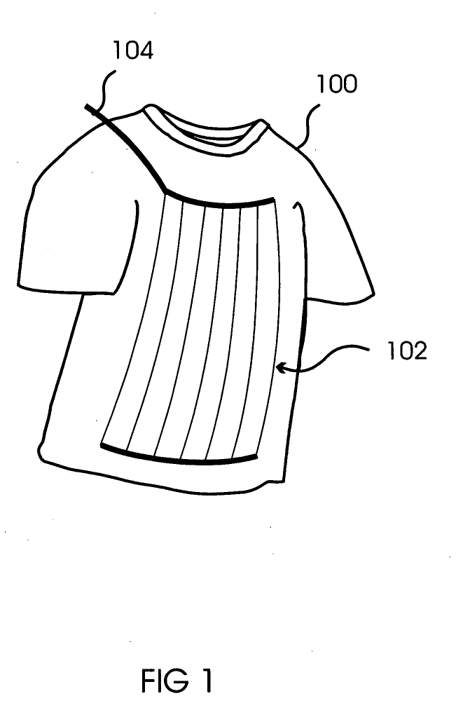

With reference to FIG. 1, the apparatus of the invention includes a garment, shown in FIG. 1 as a shirt 100, and a vascular water distribution system 102, cooperative with the garment 100. The vascular water distribution system 102 receives water through a hose 104 and distributes the water into the fabric of the garment 100. The water can be supplied from any convenient source, depending on the circumstances. For example, when using a stationary indoor exercise device water can be supplied from a plumbing system that extends throughout the building. When working or exercising outdoors, for example running or bicycling, water can be supplied from a container carried by the individual or obtained from watering stations along the exercise route. The latter options are discussed in more detail below.

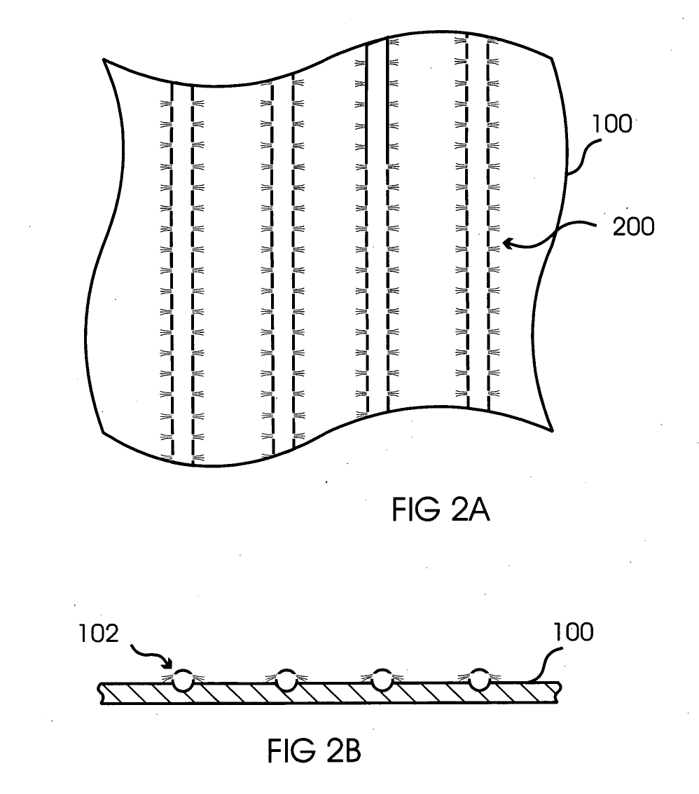

FIG. 2A and FIG. 2B present close-up views of the fabric 100 used in the shirt of FIG. 1. In FIG. 1A, it can be seen that water channels 200 of the vascular water distribution system 102 are attached at intervals to the fabric 100, and that they have small outlet holes through which water is sprayed onto the fabric 100. In the cross sectional view of FIG. 2B it can be better seen that the channels 200 in this embodiments protrude partially above the outer surface of the shirt 100, and spray water onto the surrounding fabric 100. In the embodiment illustrated by FIG. 2A and FIG. 2B the channels themselves 200 are not permeable to water, except through small holes purposely set in the channels 200. In similar embodiments, the channels are made from cloth or other material that is semi-permeable to water, so that it is not necessary to include holes specifically to allow the water to pass from the channels 200 to the shirt 100.

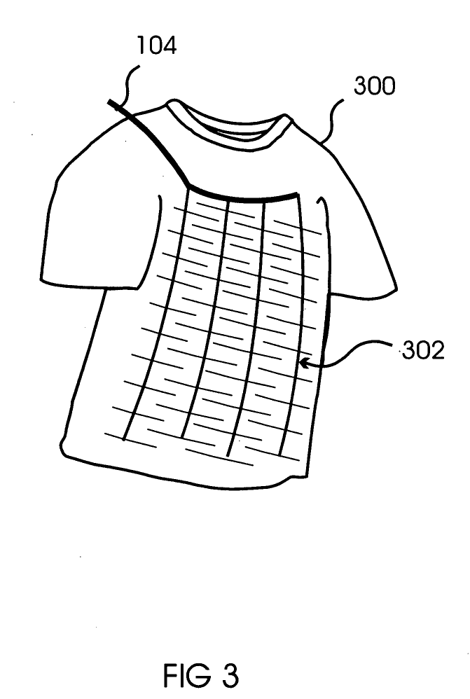

FIG. 3 illustrates a shirt 300 similar to the shirt 100 of FIG. 1, except that the vascular water distribution system 302 includes smaller channels that branch out from larger main channels. The channel holes in this embodiment are in direct contact with the surrounding shirt 300, and the surface tension of the water causes water to be drawn through the channels 302 by capillary action, as compared to water being driven through the channels 200 under pressure in the embodiment of FIG. 1. In some embodiments, the smaller channels are woven into the fabric, essentially becoming part of the fabric.

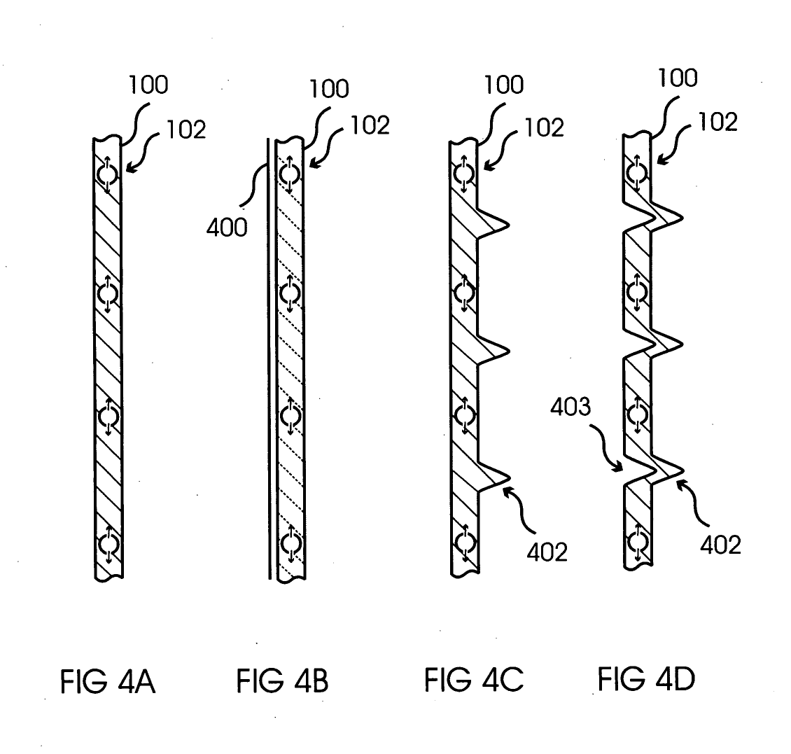

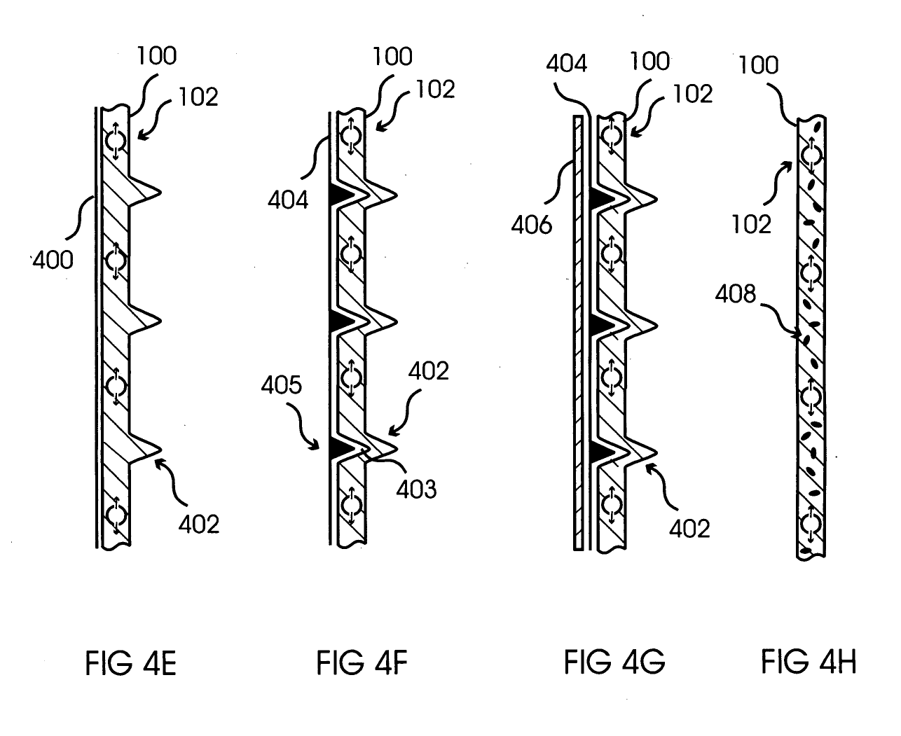

FIG. 4A through FIG. 4H, inclusively, present and compare garment fabric designs from different embodiments of the invention, all of which include vascular water distribution systems 102, 300 with channels 102 embedded in the fabric that have holes through which water is dispensed under pressure onto the fabric 100. However, the variations illustrated in FIG. 4A through FIG. 4H are equally applicable to embodiments in which capillary action and/or some other water distribution method is active, and/or embodiments in which the vascular water distribution system is attached to the surface of the fabric and sprays water onto the fabric, as discussed with reference to FIG. 2B above.

FIG. 4A essentially reproduces FIG. 2B, except that the channels 102 are embedded in the fabric 100. In FIG. 4B, a barrier 400 is included on the inside surface of the fabric 100, which serves as a thermally conducting, water resistant barrier that keeps a user both cool and dry. In FIG. 4C and FIG. 4D, texture 402 is included in the fabric 100 so as to increase the surface area over which distributed water is exposed to the air, thereby increasing the rate of evaporative cooling. In FIG. 4C, the inner surface of the fabric 100 remains smoothly in contact with a user by allowing the thickness of the fabric to vary according to the texture 402, while in FIG. 4D the inner surface follows the texture 402, maintaining a constant thickness of fabric 100 and creating indentations 403 in the inner surface of the fabric at locations where the fabric protrudes outward.

The embodiment of FIG. 4E combines the enhancements of FIG. 4B and FIG. 4C by including both a barrier 400 and texture 402 in the fabric 100. Similarly, the embodiment of FIG. 4F combines the enhancements of FIG. 4B and FIG. 4D. The barrier 400 is made from a thermally conductive material and fills the indentations 403 due to the texture 402 with protrusions 405 in the barrier 400, so that the thickness of the fabric 100 remains essentially uniform and the inner surface of the barrier maintains maximum thermal contact with the user.

In the embodiment of FIG. 4G an additional padding layer 406 is included on the innermost surface. This padding layer 406 increases the comfort of the wearer by providing a layer of cloth that is chosen to be non-irritating to the skin, and in some embodiments can also absorb any perspiration that forms on the skin.

The embodiment of FIG. 4H is similar to the embodiment of FIG. 4A, except that water absorbent particles 408 are embedded in the fabric 100. The water absorbent particles 408, which in preferred embodiments are gel polymers, moderate the degree of wetness of the fabric 100 by absorbing water when too much water is applied, and releasing water when too little water is present.

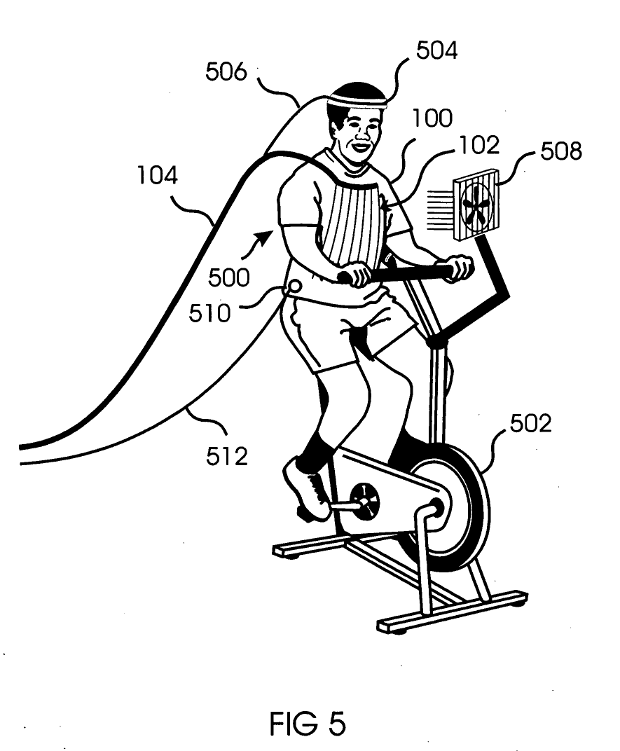

FIG. 5 is a perspective drawing showing an exerciser 500 using a stationary exercise device 502 while wearing the shirt 100 of FIG. 1 as well as an evaporatively cooled headband 504. Water is supplied to the shirt 100 and to the headband 504 through hoses 104, 506, from a plumbing system not shown in the figure. So as to further increase the cooling effect, a fan 508 is used to blow air onto the shirt and increase the rate of evaporative cooling. Also, a sensor 510 attached to a wire 512 is used to monitor the degree of wetness of the shirt 100 and limit the amount of water delivered to the shirt 100 and to the headband 504 if the shirt 100 gets too wet.

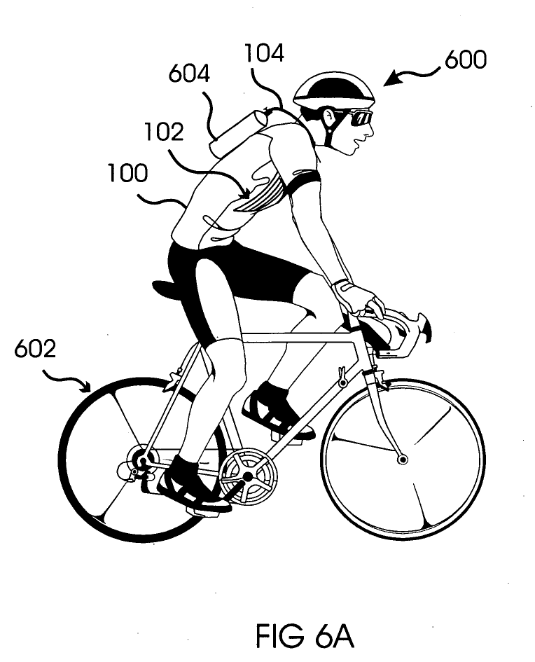

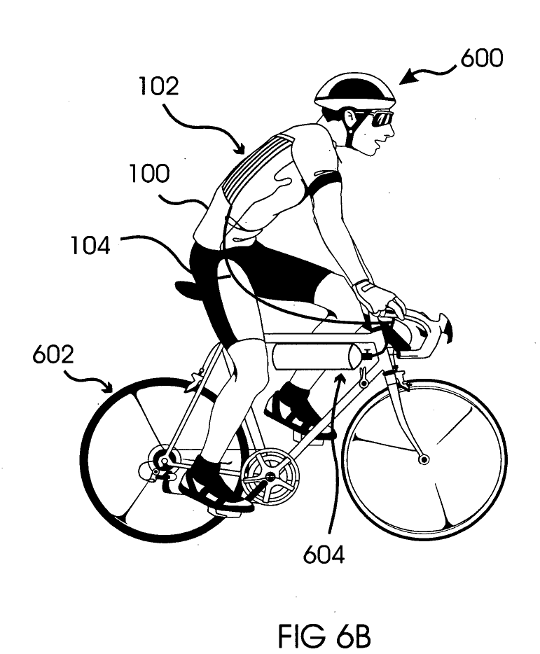

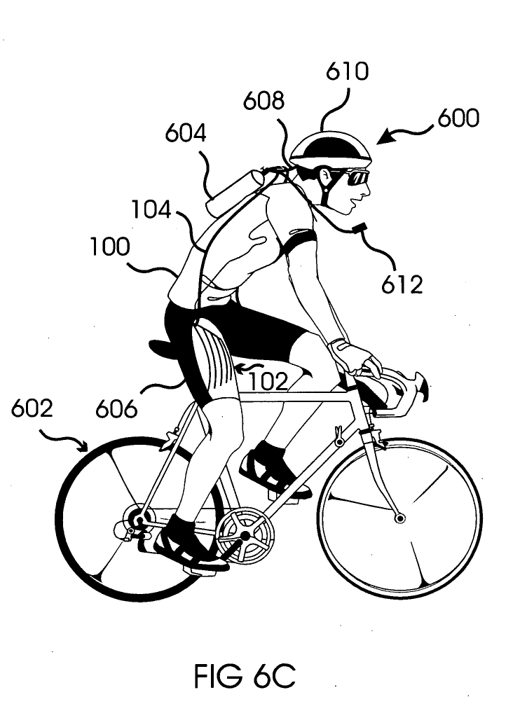

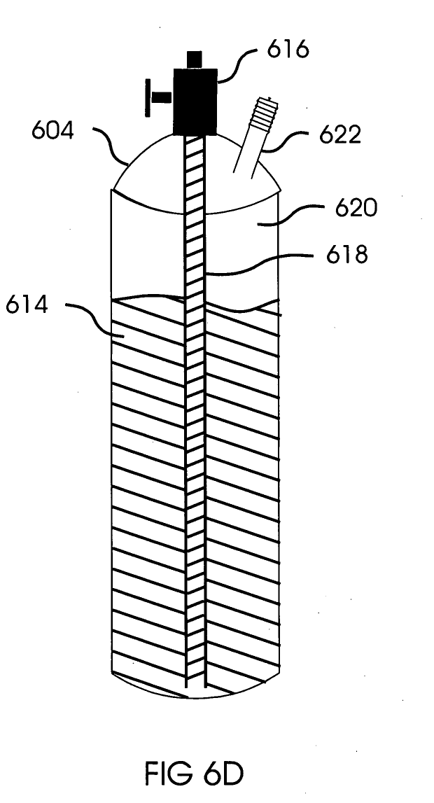

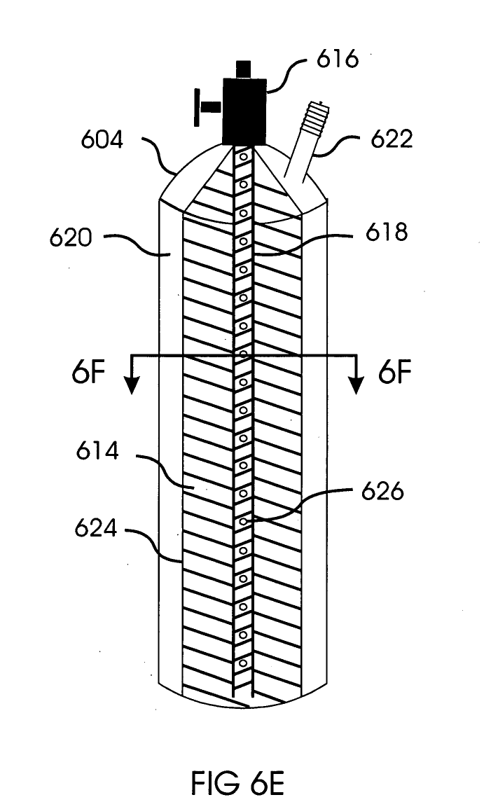

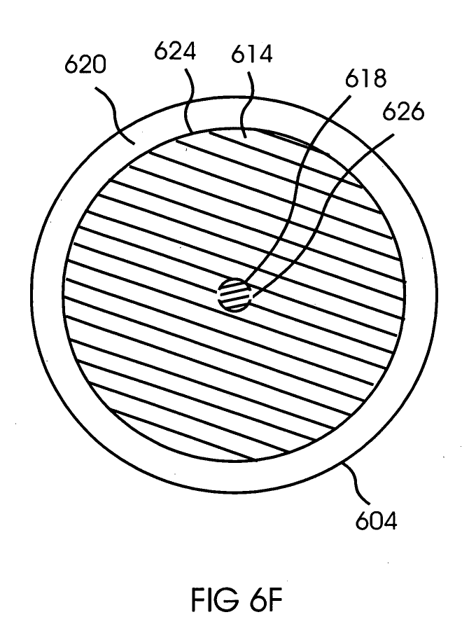

FIG. 6A is a perspective drawing of an exerciser 600 riding a bicycle 602 while wearing the shirt 100 of FIG. 1. Water is drawn to the shirt 100 by gravity from a water bottle 604 attached to the back of the individual 600. A flow of air resulting from movement of the bicycle 602 enhances the evaporative cooling of the shirt 100. FIG. 6B is a perspective drawing of an embodiment similar to FIG. 6A, except that the water bottle 604 is attached to a supporting bar of the bicycle 602 rather than to the back of the exerciser 600. In this embodiment, the exerciser 600 can control the amount of water delivered to the shirt 100 by pressing on a water pump handle (not shown) conveniently positioned on the handlebars of the bicycle 602.

Exercise performance can sometimes be enhanced by cooling the muscles that are performing the most exercise. In FIG. 6C, an exerciser 600 is riding a bicycle 602 while wearing shorts 606 cooled by a vascular water distribution system 102 that distributes water by gravity to the cooling shorts 606 from a water bottle 604 attached to the back of the exerciser 600. In FIG. 6C, the bicycle rider's head is also cooled by supplying water 608 from the water bottle 604 to a vascular water distribution system located inside of the rider's helmet 610. The helmet 610 includes vents that allow a flow of air due to the movement of the bicycle to reach the inside of the helmet 610 and cool the bicycle rider's head by evaporation. Water from the water bottle 604 is also supplied to a drinking port 612 located near the mouth of the bicycle rider, allowing the water to be used for drinking as well as cooling. In addition, the bicycle rider can force water from the bottle into the vascular water distribution system by blowing into the drinking port 612.

FIG. 6D presents a cross sectional diagram of the water bottle 604 shown in FIG. 6A. Water 614 can be contained in the bottle 604 and dispensed through a fitting 616 mounted at one end of the bottle 604. The water 614 flows to the fitting 616 through a tube 618 that draws the water 614 from the bottom of the bottle 604. An air space 620 located above the water 614 can be filled with pressurized air using an air fitting 622, thereby causing the water to flow into the vascular water system under pressure. The embodiment of FIG. 6D is appropriate for circumstances where the bottle 604 will be maintained in a substantially upright orientation, as shown in FIG. 6A.

FIG. 6E illustrates a water bottle 604 used in embodiments where the orientation of the bottle 604 will not necessarily be vertical, for example as shown in FIG. 6B. In FIG. 6E, compressed air 620 is separated from the water 614 by a flexible membrane 624 that allows the air 620 to apply pressure to the water 614, but prevents the air 620 from being accidentally drawn out of the bottle 604 instead of the water 614. The central tube 618 in this embodiment includes holes 626 that allow water to enter the tube 618 at a plurality of locations along its length, thereby preventing any blockage of water flow as the membrane 624 collapses inward. FIG. 6F presents a cross section of the water bottle of FIG. 6E.

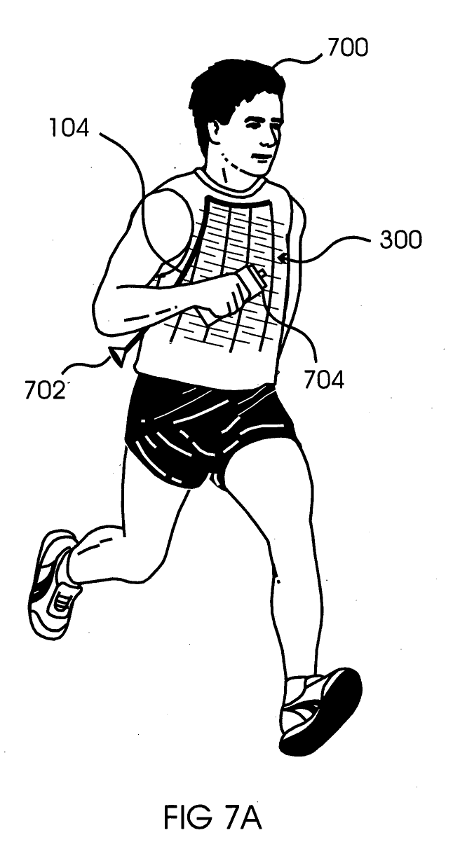

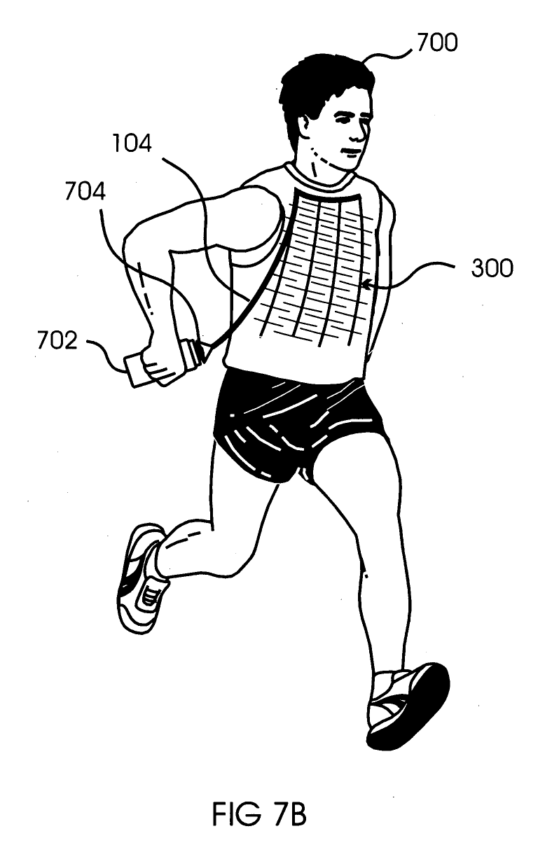

FIG. 7A is a perspective drawing of an exerciser 700 running while wearing the shirt 300 of FIG. 3. The hose 104 that supplies water to the cooling channels 302 of the shirt 300 terminates in a connection port 702 that can be attached to a compressible water bottle 704 carried by the runner 700 so as to deliver water to the shirt 300 when the bottle is connected to the connection port and squeezed by the runner 700. FIG. 7B illustrates the preferred embodiment of FIG. 7A with the water bottle 704 connected to the connection port 702.

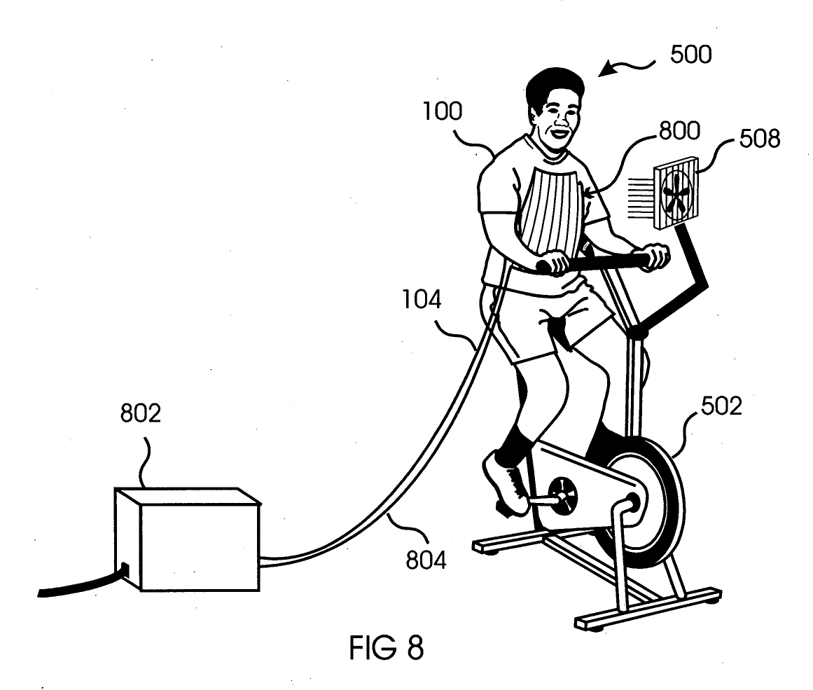

FIG. 8 is a perspective drawing of an exerciser 500 using a stationary exercise device 502 similar to the device shown in FIG. 5. The exerciser 500 in FIG. 8 is using the exercise device 502 while wearing a shirt 100 that includes a thermally conductive vascular water distribution system 800 through which chilled water is circulated by a water chiller 802 connected to the vascular water distribution system 800 by hoses 104, 804. The thermally conductive vascular water distribution system 800 brings the chilled water into thermal contact with the exerciser 500 before the water is distributed onto the shirt 100, thereby cooling the exerciser 500 both by direct convection and by evaporation. The chiller 802 includes both a cooling unit and a water pump.

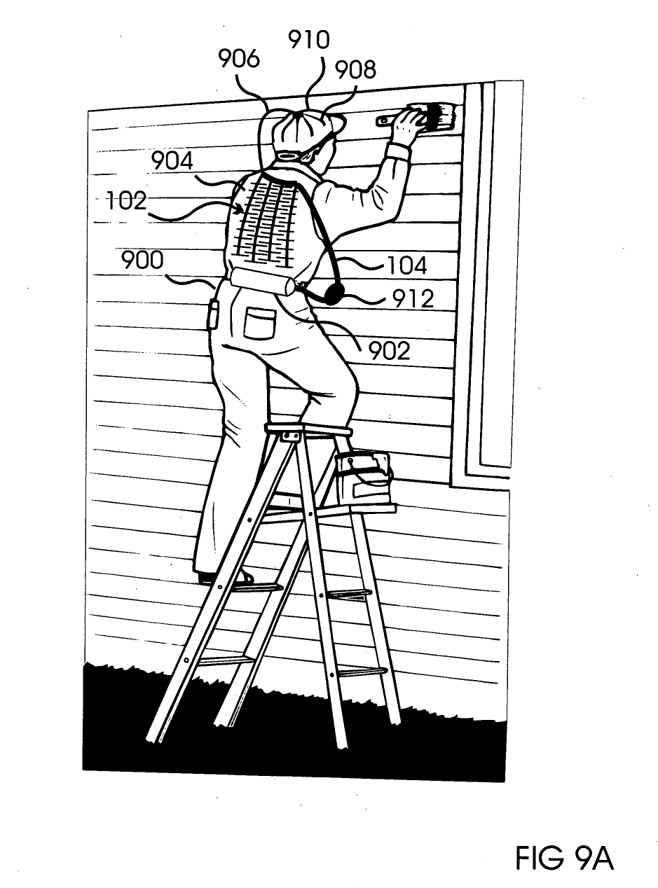

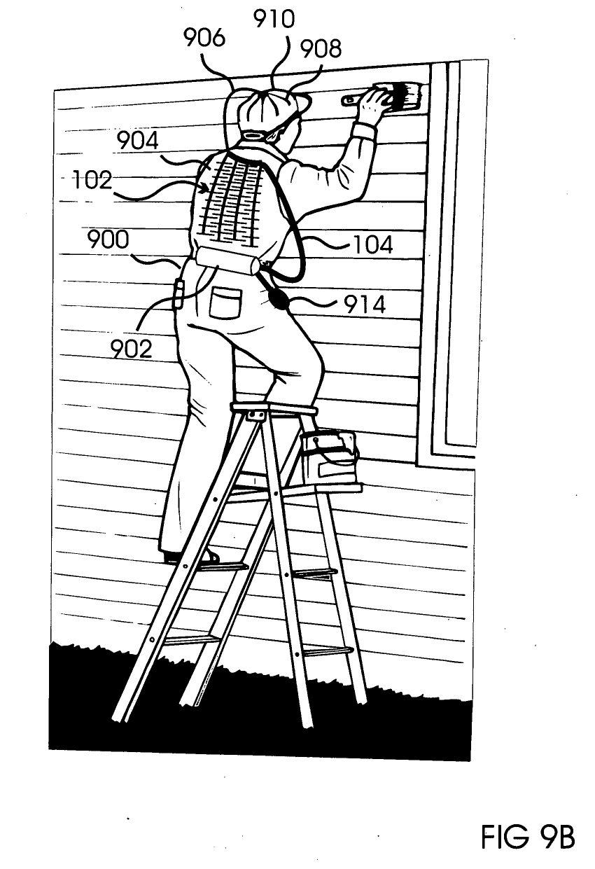

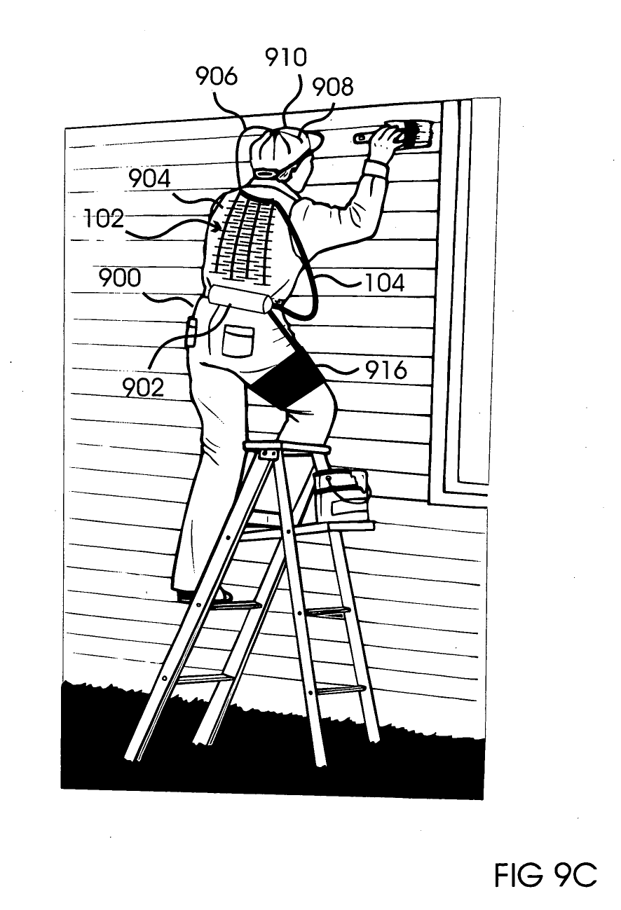

FIG. 9A illustrates use of the present invention to cool a worker performing outdoor work that could otherwise lead to overheating. In FIG. 9A, a house painter 900 is painting the exterior of a house on a warm day while standing in direct sunlight. A bottle 902 strapped to his waist supplies water through a first hose 104 to a vascular water distribution system 102 attached to a shirt 904 worn by the painter 900. A second hose 906 delivers water to a second vascular water distribution system 908 in a cap 910 worn by the painter 900, so as to cool the painter's head. In the embodiment of FIG. 9A, the house painter 900 pumps water into the vascular water distribution systems 102, 908 by squeezing on a pumping bulb 912 located along the first hose 104.

FIG. 9B illustrates an embodiment similar to FIG. 9A, except that the water bottle 902 contains pressurized air that forces water into the vascular water distribution systems 102, 908. The painter 900 uses a squeezable pump 914 to maintain the pressure of the air inside of the water bottle 902. In this embodiment, water is pushed continuously through the vascular water distribution systems 102, 908 by the pressurized air, thereby maintaining continuous cooling of the painter 900 while requiring the painter 900 to operate the pump only occasionally so as to maintain pressure in the water bottle 902.

FIG. 9C is similar to FIG. 9B, except that the air in the water bottle 902 is automatically pressurized by a pump 916 attached to the leg of the house painter 900, such that the pump 916 is actuated automatically by the natural movements of the house painter 900.

Other modifications and implementations will occur to those skilled in the art without departing from the spirit and the scope of the invention as claimed. Accordingly, the above description is not intended to limit the invention except as indicated in the following claims.

What is claimed is:

1. A garment for cooling an individual, the garment comprising:
fabric formed so as to cover at least a portion of the body of the individual; and
a vascular water distribution system cooperative with the fabric, the vascular water distribution system being connectable to a source of water; and
the vascular water distribution system being able to distribute water over an area of the fabric, thereby enabling evaporative cooling of a portion of the body of the individual.

2. The garment of claim 1, wherein the vascular water distribution system is attached to the fabric by at least one of:
hook-and-loop fabric attachment;
glue;
tie strips;
magnetic attachment;
buttons;
hooks;
pins; and
snaps.

3. The garment of claim 1, wherein at least part of the vascular water distribution system is one of embedded and woven into the fabric.

4. The garment of claim 1, wherein water flows through the vascular water distribution due to at least one of:
pressure applied to the water;
capillary action; and
gravity.

5. The garment of claim 1, wherein the vascular water distribution system is in thermal contact with the individual, thereby allowing water flowing through the vascular water distribution system to cool the individual.

6. The garment of claim 1, wherein the vascular water distribution system further comprises a connecting port that is temporarily connectable to a source of water.

7. The garment of claim 1, further comprising a drinking port that that is attachable to the source of water and can be used by the individual to drink from the source of water.

8. The garment of claim 7, wherein water can be pushed into the vascular water distribution system by blowing into the drinking port.

9. The garment of claim 1, wherein the fabric forms one of a shirt, shorts, and a hat.

10. The garment of claim 1, wherein the fabric includes a thermally conducting inner layer with a side that is in thermal contact with the individual and a side that is in thermal contact with the water.

11. The garment of claim 10, wherein the thermally conducting inner layer contains at least one of metal and thermally conducting polymer.

12. The garment of claim 10, wherein the thermally conducting inner layer at least inhibits water from coming into contact with the individual.

13. The garment of claim 1, wherein the fabric brings water into physical contact with the individual.

14. The garment of claim 1, wherein the fabric includes an inner layer that at least one of improves the comfort of the individual, absorbs perspiration, and resists exposure of the skin of the individual to water.

15. The garment of claim 1, wherein at least one quality of the fabric is non-uniform, such that the fabric tends to concentrate water in areas where evaporative cooling is most desirable.

16. The garment of claim 1, wherein the fabric includes a water absorbent substance embedded in the fabric that moderates the wetness of the fabric by absorbing water from the fabric when too much is applied by the vascular water distribution system, and releasing water into the fabric when insufficient water is applied by the vascular water distribution system.

17. The garment of claim 1, wherein the fabric includes outer surface shaping that provides increased surface area, so as to increase evaporative cooling.

18. The garment of claim 17 wherein the fabric is one of:
uniform in thickness, such that the fabric includes both outer surface shaping and inner surface shaping; and
non-uniform in thickness, such that the fabric includes only outer surface shaping.

19. The garment of claim 1, wherein the fabric includes a thermally conducting inner layer and a water absorbent outer layer, the water absorbent outer layer being uniform in thickness and including both outer and inner shaping, the inner layer having a side that is in thermal contact with the individual and a side that is in thermal contact with the outer layer, the side that is in thermal contact with the outer layer conforming in shape to the inner surface shaping of the outer layer.

20. The garment of claim 1, further comprising a source of water able to supply water to the vascular water distribution system.

21. The garment of claim 20, wherein the source of water includes a water chiller that is able to cool the water before it is distributed by the vascular water distribution system.

22. The garment of claim 20, wherein the source of water includes a pump operable by the individual so as to pump water into the vascular water distribution system.

23. The garment of claim 22, wherein the pump is operated automatically when the body of the individual undergoes movement that is at least one of:
breathing;
walking;
moving of arms;
moving of legs;
and other body movements.

24. The garment of claim 20, wherein the source of water includes an air space cooperative with water contained in the source of water, the air space being fillable with compressed air so as to apply pressure to the water, thereby pushing the water into the vascular water distribution system.

25. The garment of claim 24, wherein the air space is separated from the water in the source of water by a flexible barrier that is able to apply pressure to the water while ensuring that only water will be delivered by the source of water to the vascular water distribution system.

26. The garment of claim 24, wherein the source of water includes a pump operable by the individual so as to compress the air in the air space.

27. The garment of claim 26, wherein the pump is operated automatically when the body of the individual undergoes movement that is at least one of:
breathing;
walking;
moving of arms;
moving of legs;
and other body movements.

28. The garment of claim 20, wherein the source of water includes a water container that can be compressed by the individual so as to push water into the vascular water distribution system.

29. The garment of claim 20, wherein at least some of the water supplied by the source of water is maintained in thermal contact with the individual before it is delivered to the vascular water distribution system.
